(19) United States
(12) Patent Application Publication
(10) Pub. No.: US 2026/0230128 A1
(43) Pub. Date: Aug. 6, 2026

(54) USER EQUIPMENT, BASE STATION, AND METHOD FOR CODEBOOK BASED PUSCH TRANSMISSION

(71) Applicant: SHARP KABUSHIKI KAISHA, Sakai City, Osaka (JP)

(72) Inventors: PO-CHUN CHOU, Taipei (TW); CHIA-HUNG LIN, Taipei (TW); MEI-JU SHIH, Taipei (TW); WAN-CHEN LIN, Taipei (TW); YEN-HUA LI, Taipei (TW)

(21) Appl. No.: 19/151,439

(22) PCT Filed: Feb. 1, 2024
(86) PCT No.: PCT/CN2024/075135

§ 371 Date: Jul. 28, 2025

Related U.S. Application Data
(60) Provisional application No. 63/443,027, filed on Feb. 2, 2023.

(51) Int. Cl. H04B 7/0456; H04L 5/00; H04W 72/21; H04W 72/232

(52) U.S. Cl. CPC H04B 7/0456; H04L 5/0051; H04W 72/21; H04W 72/232

(57) ABSTRACT

A method performed by a user equipment (UE) for codebook based Physical Uplink Shared Channel (PUSCH) transmission is provided. The method includes receiving, from a base station (BS), a PUSCH configuration via Radio Resource Control (RRC) signaling, the PUSCH configuration including a first parameter indicating grouping information for eight transmission antenna ports of the UE; receiving, from the BS, first DCI including a first field and a second field, the first field indicating an 8-port Sounding Reference Signal (SRS) resource corresponding to the eight transmission antenna ports, and the second field indicating an index; determining a dedicated table based on the first parameter; determining a first precoding matrix based on the dedicated table and the index; and performing codebook based PUSCH transmission using the first precoding matrix.

### FIELD

The present disclosure is related to wireless communication and, more specifically, to user equipment (UE), base station (BS), and method for codebook based Physical Uplink Shared Channel (PUSCH) transmission in cellular wireless communication networks.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a UE, a BS, and a method for a codebook based PUSCH transmission in cellular wireless communication networks.

In a first aspect of the present application, a method performed by a UE for codebook based PUSCH transmission is provided. The method includes receiving, from a BS, a PUSCH configuration via Radio Resource Control (RRC) signaling, the PUSCH configuration including a first parameter indicating grouping information for eight transmission antenna ports of the UE; receiving, from the BS, first DCI including a first field and a second field, the first field indicating an 8-port Sounding Reference Signal (SRS) resource corresponding to the eight transmission antenna ports, and the second field indicating an index; determining a dedicated table based on the first parameter; determining a first precoding matrix based on the dedicated table and the index; and performing codebook based PUSCH transmission using the first precoding matrix.

In an implementation of the first aspect, the first DCI comprises one of a DCI format 0_1 or a DCI format 0_2.

In another implementation of the first aspect, the first parameter indicates a number of antenna groups, and transmission antenna ports that belong to a same antenna group are regarded as coherent.

In another implementation of the first aspect, the index corresponds to a plurality of sub-indices, the first precoding matrix is obtained according to a plurality of second precoding matrices, the plurality of second precoding matrices correspond to the plurality of sub-indices, and each of the plurality of second precoding matrices is used for four transmission antenna ports or two transmission antenna ports.

In another implementation of the first aspect, the PUSCH configuration further includes a maximum transmission rank, a transform precoding configuration, and a full power mode configuration, and the dedicated table is determined further based on the maximum transmission rank, the transform precoding configuration, and the full power mode configuration.

In another implementation of the first aspect, a maximum value of the maximum transmission rank is eight.

In another implementation of the first aspect, the dedicated table has two columns for each value of the maximum transmission rank, the first column of the dedicated table corresponds to the index, and the second column of the dedicated table corresponds to a combination of a number of transmission layers and a Transmitted Precoding Matrix Indicator (TPMI).

In a second aspect of the present application, a UE for codebook based PUSCH transmission is provided. The UE includes one or more processors and at least one memory coupled to at least one of the one or more processors. The at least one memory stores computer-executable instructions that, when executed by the at least one of the one or more processors, cause the UE to: receive, from a BS, a PUSCH configuration via RRC signaling, the PUSCH configuration including a first parameter indicating grouping information for eight transmission antenna ports of the UE; receive, from the BS, first DCI including a first field and a second field, the first field indicating an 8-port SRS resource corresponding to the eight transmission antenna ports, and the second field indicating an index; determining a dedicated table based on the first parameter; determining a first precoding matrix based on the dedicated table and the index; and performing codebook based PUSCH transmission using the first precoding matrix.

In a third aspect of the present application, a BS for configuring codebook based PUSCH transmission is provided. The BS includes one or more processors and at least one memory coupled to at least one of the one or more processors. The at least one memory stores computer-executable instructions that, when executed by the at least one of the one or more processors, cause the BS to: transmit, to a UE, a PUSCH configuration via Radio Resource Control (RRC) signaling, the PUSCH configuration including a first parameter indicating grouping information for eight transmission antenna ports of the UE; and transmit, to the UE, first DCI including a first field and a second field, the first field indicating an 8-port SRS resource corresponding to the eight transmission antenna ports, and the second field indicating an index. The PUSCH configuration and the first DCI enable the UE to: determine a dedicated table based on the first parameter; determine a first precoding matrix based on the dedicated table and the index; and perform codebook based PUSCH transmission using the first precoding matrix.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process for codebook based PUSCH transmission performed by a UE, according to an example implementation of the present disclosure.

FIG. 2 is a flowchart illustrating a method/process for configuring codebook based PUSCH transmission performed by a BS, according to an example implementation of the present disclosure.

FIG. 3 is a block diagram illustrating a node for wireless communication, according to an example implementation of the present disclosure.

### DESCRIPTION

Some abbreviations used in the present disclosure include:

DESCRIPTION
Some abbreviations used in the present disclosure include:

| Abbreviation | Full name |
|---|---|
| 3GPP | 3^{rd} Generation Partnership Project |
| 5G | 5^{th} Generation |
| ACK | Acknowledgment |
| BS | Base Station |
| BWP | Bandwidth Part |
| C-RNTI | Cell Radio Network Temporary Identifier |
| CA | Carrier Aggregation |
| CB | Codebook-Based |
| CC | Component Carrier |
| CG | Configured Grant |
| CN | Core Network |
| CPE | Customer Premises Equipment |
| CRC | Cyclic Redundancy Check |
| CS-RNTI | Configured Scheduling Radio |
| | Network Temporary Identifier |
| CSI-RS | Channel State Information Reference Signal |
| DC | Dual Connectivity |
| DCI | Downlink Control Information |
| DL | Downlink |
| DMRS | Demodulation Reference Signal |
| E-UTRA | Evolved Universal Terrestrial Radio Access |
| FDD | Frequency Division Duplexing |
| FR | Frequency Range |
| FWA | Fixed Wireless Access |
| HARQ | Hybrid Automatic Repeat Request |
| HARQ-ACK | HARQ Acknowledgement |
| ID | Identifier |
| IE | Information Element |
| LTE | Long Term Evolution |
| MAC | Medium Access Control |
| MAC CE | MAC Control Element |
| MCG | Master Cell Group |
| MCS | Modulation Coding Scheme |
| MIMO | Multi-Input Multi-Output |
| MN | Master Node |
| MsgA | Message A |
| NAS | Non Access Stratum |
| NDI | New Data Indicator |
| NR | New Radio |
| NW | Network |
| OFDM | Orthogonal Frequency Division Multiplexing |
| PCell | Primary Cell |
| PDCCH | Physical Downlink Control Channel |
| PDSCH | Physical Downlink Shared Channel |
| PHY | Physical (layer) |
| PRACH | Physical Random Access Channel |
| PUCCH | Physical Uplink Control Channel |
| PUSCH | Physical Uplink Shared Channel |
| RA | Random Access |
| RAN | Radio Access Network |
| RAR | Random Access Response |
| Rel | Release |
| RI | Rank Indicator |
| RF | Radio Frequency |
| RNTI | Radio Network Temporary Identifier |
| RRC | Radio Resource Control |
| RS | Reference Signal |
| SCell | Secondary Cell |
| SCG | Secondary Cell Group |
| SN | Secondary Node |
| SP-CSI-RNTI | Semi-Persistent Channel State |
| | Information RNTI |
| SRI | SRS Resource Indicator |
| SRS | Sounding Reference Signal |
| TB | Transport Block |
| TC-RNTI | Temporary Cell RNTI |
| TDD | Time Division Duplexing |
| TPMI | Transmit Precoding Matrix Indicator |
| TRI | Transmission Rank Indication |
| TRP | Transmission Reception Point |
| TS | Technical Specification |
| TX | Transmission |
| UE | User Equipment |
| UL | Uplink |
| URLLC | Ultra-Reliable and Low-Latency |
| | Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

It should be noted that the “an antenna port” and “antenna ports” mentioned in the present disclosure may be referred to “an antenna port used for transmission of PUSCH(s)/PUCCH(s)” and “antenna ports used for transmission of PUSCH(s)/PUCCH(s)”.

Multi-Input Multi-Output (MIMO) is one of the key technologies in NR systems and is successful in commercial deployments. MIMO features were investigated and specified for both Frequency Division Duplexing (FDD) and Time Division Duplexing (TDD) systems, of which major parts were for downlink MIMO operation. It is important to identify and specify necessary enhancements for uplink MIMO. Also, necessary enhancements on downlink MIMO that facilitate the use of large antenna array, not only for Frequency Range 1 (FR1) but also for Frequency Range 2 (FR2), would still be needed to fulfill the request for evolution of NR deployments. This may include following enhancements.

Specify UL DMRS, SRS, SRI, and TPMI (including codebook) enhancements to enable 8 Transmission Uplink operation (8 TX UL operation) to support 4 and more layers per UE in UL targeting Customer Premises Equipment (CPE), Fixed Wireless Access (FWA), vehicle, or industrial devices. Potential restrictions on the scope of this objective (including coherence assumption, full/non-full power modes) may be identified. It should be noted that the 8 TX UL operation may mean that a UE has eight antenna ports in UL transmission.

MIMO technology is an effective way to increase the throughput of NR systems, and one of the key features is beamforming. Beamforming may be achieved by using a precoder in a multi-antenna system (e.g., analog beamforming, digital beamforming, or hybrid beamforming). However, how to determine the precoder is a practical problem in NR systems, involving resource allocation (such as SRS resource), indication signaling (such as SRI and TPMI), etc. Based on hardware improvements, UL MIMO operation supporting up to 8TX transmission may be possible, which may lead to improvement in system throughput. In order to support 8TX UL transmission, some enhanced mechanisms may need to be established, such as UE capability report (e.g., the maximum number of antenna ports may reach eight), SRS configuration (e.g., SRS configurations may support UL CB transmission with 8TX UE), PUSCH configuration (e.g., UL MIMO operation may support a UE with 8TX), precoders selection (e.g., enhanced SRI and TPMI), etc. Mechanisms are proposed in the present disclosure to overcome problems related to indicating precoders in 8TX UL transmission.

### UE Capability Report

A UE may be configured with uplink CB transmission when a higher layer parameter txConfig in a PUSCH configuration (e.g., pusch-Config IE), which may be included in an RRC message, from a base station (e.g., gNB) is set to ‘codebook’. In these cases, the UE may report information about the supported maximum number of MIMO layers (e.g., using the field maxNumberMIMO-LayersCB-PUSCH in FeatureSetUplinkPerCC or other feature sets for per CC, per band, or per CC group scheduling IE), the maximum number of SRS resources per SRS resource set (e.g., using the parameter maxNumberSRS-ResourecePerSet in FeatureSetUplinkPerCC or other feature sets for per CC, per band, or per CC group scheduling IE), and/or the support of the uplink codebook subset (e.g., using one field containing the coherence information and the antenna group information, or two fields containing the coherence information and the antenna group information separately in MIMO-ParametersPerBand IE included in an RRC message), to the base station. The coherence information may be fully coherent, partially coherent, or non-coherent.

An antenna group may include antenna ports for joint or disjoint transmission. For example, antenna ports in an antenna group may be fully coherent or partially coherent, or non-coherent. On the other hand, the antenna group information may indicate the number of antenna groups of the UE. The codebook subset may be applied to CB transmission and specify the subset of the codebook. The fully coherent codebook subset may include precoding matrices that enable a single layer to use all antenna ports for joint transmission. The partially coherent codebook subset may include precoding matrices that enable a single layer to use partial antenna ports for joint transmission. The noncoherent codebook subset may include precoding matrices that enable a single layer to use one antenna port for transmission.

In some implementations, antenna ports in an antenna group may be coherent with each other. All antenna groups may be in one panel or each antenna group may be in each panel separately. For the support of uplink codebook subset, one field indicating the coherence information and the antenna group information may be set to nonCoherent, partialNg_2Coherent, or partialNg_4Coherent or fullNg_2Coherent or fullNg_4Coherent. Two fields indicating the coherence information and the antenna group information respectively may include the first field set to nonCoherent, partialCoherent, or fullCoherent and the second field set to ‘Ng_2’ or ‘Ng_4’. These fields may be replaced by other fields. Moreover, the above information may be included in an RRC message (e.g., UE Capability Information message). N_{g} may represent the number of antenna groups. When supporting partial-coherent codebook subset, if N_{g}=2, two antenna groups may be non-coherent to each other. When supporting partial-coherent codebook subset, if the second field (e.g., associated with N_{g}) is absent, each antenna group may be coherent with any other antenna groups except for the case where coherence is established with all antenna groups. If N_{g}=4, a UE may report the coherence relationship between antenna groups to the gNB in an IE (included in an RRC message), unless non-coherent across antenna groups.

In some implementations, when the gNB sends UECapabilityEnquiry message (e.g., an RRC message) to a UE or when the UE receives UECapabilityEnquiry message from the gNB, the UE may report, to the gNB, at least one of the maximum number of supporting layers, the maximum number of SRS resources per SRS Resource Set, and the support of the uplink codebook subset. The maximum number of supporting layers may be one, two, four, or eight. The maximum number of SRS resources per SRS Resource Set may be one, two, four, or eight. The support of the uplink codebook subset may be full-coherence. Moreover, the UE may expect that the gNB may configure/schedule the transmission rank equal to the maximum number of supporting layers to achieve the highest data rate. However, the gNB may determine the transmission rank according to the measurement result (e.g., measuring the SRS signal from the UE) and the transmission rank may be less than or equal to the maximum number of supporting layers. For example, when the UE reports that the maximum number of supporting layers is two or when the gNB receives the UE's report including the information that the maximum number of supporting layers is two, the gNB may configure/schedule the transmission rank as one or two according to the measurement result. On the other hand, the gNB may configure multiple SRS resources for the UE, according to the maximum number of SRS resources per SRS resource set, the support of the uplink codebook subset, and/or different usages (e.g., multi-panel transmission). The number of configured SRS resources in each SRS resource set may be less than the maximum number of SRS resources per SRS resource set. In addition, the UE that indicates support of fully coherent codebook subset may also support partial and non-coherent codebook subset. It should be noted that the UE may refer to, but not limited to, a device with eight fully coherent antenna ports.

In some implementations, when the gNB sends UECapabilityEnquiry message (e.g., an RRC message) to a UE or when the UE receives UECapabilityEnquiry message from the gNB, the UE may report, to the gNB, at least one of the maximum number of supporting layers, the maximum number of SRS resources per SRS Resource Set, the support of the uplink codebook subset, and the number of antenna groups N_{g}. The maximum number of supporting layers may be one, two, four, or eight. The maximum number of SRS resources per SRS Resource Set may be one, two, four, or eight. The support of the uplink codebook subset may be full-coherence. The number of antenna groups N_{g} may be two or four. Moreover, the UE may expect that the gNB may configure/schedule the transmission rank equal to the maximum number of supporting layers to achieve the highest data rate. However, the gNB may determine the transmission rank according to the measurement result (e.g., measuring the SRS signal(s) transmitted from the UE) and the transmission rank may be less than or equal to the maximum number of supporting layers. For example, when the UE reports that the maximum number of supporting layers is two or when the gNB receives the UE's report including the information that the maximum number of supporting layers is two, the gNB may configure/schedule the transmission rank as one or two. On the other hand, the gNB may configure multiple SRS resources for the UE, according to the maximum number of SRS resources per SRS resource set, the support of the uplink codebook subset, and/or different usages (e.g., multi-panel transmission). The number of configured SRS resources in each SRS resource set may be less than the maximum number of SRS resources per SRS resource set. In addition, the UE that indicates support of fully coherent codebook subset may also support partial and non-coherent codebook subset. It should be noted that the UE may refer to, but not limited to, a device with eight fully coherent antenna ports.

In some implementations, a UE may report, to the gNB, at least one of the maximum number of supporting layers, the maximum number of SRS resources per SRS Resource Set, the support of the uplink codebook subset, and the number of antenna groups N_{g}. The maximum number of supporting layers may be one, two, four, or eight. The maximum number of SRS resources per SRS Resource Set may be one, two, four, or eight. The support of the uplink codebook subset may be partial-coherence. The number of antenna groups N_{g} may be two or four. Moreover, the UE may expect that the gNB may configure/schedule the transmission rank equal to the maximum number of supporting layers to achieve the highest data rate. However, the gNB may determine the transmission rank according to the measurement result (e.g., measuring the SRS signal from the UE) and the transmission rank may be less than or equal to the maximum number of supporting layers. For example, when the UE reports that the maximum number of supporting layers is two or when the gNB receives the UE's report including the information that the maximum number of supporting layers is two, the gNB may configure/schedule the transmission rank as one or two according to the measurement result. On the other hand, the gNB may configure multiple SRS resources for the UE, according to the maximum number of SRS resources per SRS resource set, the support of the uplink codebook subset, and/or different usages (e.g., multi-panel transmission). The number of configured SRS resources in each SRS resource set may be less than the maximum number of SRS resources per SRS resource set. In addition, the UE that indicates support of partially coherent codebook subset may also support non-coherent codebook subset. It should be noted that the UE may refer to, but not limited to, a device with eight partially coherent antenna ports.

In some implementations, when the gNB sends UECapabilityEnquiry message (e.g., included in an RRC message) to a UE, the UE may report, to the gNB, at least one of the maximum number of supporting layers, the maximum number of SRS resources per SRS Resource Set, and the support of the uplink codebook subset. The maximum number of supporting layers may be one, two, four, or eight. The maximum number of SRS resources per SRS Resource Set may be one, two, four, or eight. The support of the uplink codebook subset may be non-coherence. Moreover, the UE may expect that the gNB may configure/schedule the transmission rank equal to the maximum number of supporting layers to achieve the highest data rate. However, the gNB may determine the transmission rank according to the measurement result (e.g., measuring the SRS signal from the UE) and the transmission rank may be less than or equal to the maximum number of supporting layers. For example, when the UE reports that the maximum number of supporting layers is two or when the gNB receives the UE's report including the information that the maximum number of supporting layers is two, the gNB may configure/schedule the transmission rank as one or two according to the measurement result. On the other hand, the gNB may configure multiple SRS resources for the UE, according to the maximum number of SRS resources per SRS resource set, the support of the uplink codebook subset, and/or different usages (e.g., multi-panel transmission). The number of configured SRS resources in each SRS resource set may be less than the maximum number of SRS resources per SRS resource set. In addition, the UE reporting its UE capability of non-coherent transmission may not expect to be configured to support full-coherent or partial-coherent codebook subset. It should be noted that the UE may refer to, but not limited to, a device with eight non-coherent antenna ports.

In some implementations, a UE may report, to the gNB, at least one of the maximum number of supporting layers, the maximum number of SRS resources per SRS Resource Set, the support of the uplink codebook subset, and the number of antenna groups N_{g}. The maximum number of supporting layers may be one, two, four, or eight. The maximum number of SRS resources per SRS Resource Set may be one, two, four, or eight. The support of the uplink codebook subset may be non-coherence. The number of antenna groups N_{g} may be two or four. Moreover, the UE may expect that the gNB may configure/schedule the transmission rank equal to the maximum number of supporting layers to achieve the highest data rate. However, the gNB may determine the transmission rank according to the measurement result (e.g., measuring the SRS signal from a UE) and the transmission rank may be less than or equal to the maximum number of supporting layers. For example, when the UE reports that the maximum number of supporting layers is two or when the gNB receives the UE's report including the information that the maximum number of supporting layers is two, the gNB may configure/schedule the transmission rank as one or two according to the measurement result. On the other hand, the gNB may configure multiple SRS resources for the UE, according to the maximum number of SRS resources per SRS resource set, the support of the uplink codebook subset, and/or different usages (e.g., multi-panel transmission). The number of configured SRS resources in each SRS resource set may be less than the maximum number of SRS resources per SRS resource set. In addition, the UE reporting its UE capability of non-coherent transmission may not expect to be configured to support full-coherent or partial-coherent codebook subset. It should be noted that the UE may refer to, but not limited to, a device with eight non-coherent antenna ports.

In some implementations, a UE may report the maximum number of supporting layers and/or the maximum number of SRS resources per SRS resource set based on different usages, such as non-CB, CB, beam management, and/or UL antenna switching. It should be noted that the UE may refer to, but not limited to, a device with eight non-coherent antenna ports.

In some implementations, the maximum number of antenna groups may define a plurality of antenna ports in an antenna group that may be regarded as coherent. In some implementations, a BS may configure a parameter to the UE via RRC signaling for indicating the number of antenna groups. Antenna ports that belong to the same antenna group may be regarded as coherent.

In some implementations, the UE indicating support of the feature of the antenna group may also indicate the support of mimo-CB-PUSCH and/or the maximum number of supporting layers is ‘eight’.

In some implementations, the UE reporting the number of antenna groups may also report the maximum number of supported layers and the maximum number of SRS resources per SRS Resource Set to the gNB, where the information may be included in the mimo-CB-PUSCH IE. On the other hand, the maximum number of supporting layers may be up to eight. It should be noted that the UE may refer to, but not limited to, a device with eight non-coherent antenna ports.

Generally, a UE in the present disclosure may be, but not limited to, a device with eight fully coherent antenna ports, a device with eight partially coherent antenna ports, or a device with eight non-coherent antenna ports.

### SRS Configuration

One or two SRS resource sets may be configured to a UE via RRC signaling (e.g., srs-ResourceSetToAddModList or srs-ResourceSetToAddModListDCI-0-2) with higher layer parameter usage in SRS-ResourceSet set to codebook. For example, the UE may receive the RRC signaling from a serving cell or a serving gNB including a higher layer parameter usage in SRS-ResourceSet set to codebook. In response to the reception of the RRC signaling, the UE may configure itself with one or two SRS resource sets. K SRS resources may be configured per SRS resource set to a UE via RRC signaling (e.g., srs-ResourceToAddModList) with higher layer parameter usage in SRS-ResourceSet set to codebook. For each SRS resource set configured by RRC signaling (e.g., SRS-ResourceSet), the UE may be configured with K≥1 SRS resources (e.g., in response to the reception of the RRC signaling, the UE may be configured by a higher layer parameter SRS-Resource), where the maximum value of K may be based on the reported UE capability. For example, the UE may receive the RRC signaling from a serving cell or a serving gNB including higher layer parameter usage in SRS-ResourceSet set to codebook. In response to the reception of the RRC signaling, the UE may configure itself with K SRS resources per SRS resource set.

In some implementations, a UE may be configured with at least two 8-port SRS resources in each SRS resource set through RRC signaling transmitted by the gNB (e.g., the parameter nrofSRS-Ports in SRS-Resource may support up to 8 antenna ports). Moreover, this configuration may be applied to the UE with the capability that supports fully/partial/non-coherent codebook set and be used for multi-TRP/panel transmission. It should be noted that the UE may refer to, but not limited to, a device with 8 antenna ports in a single antenna group (e.g., N_{g}=1).

In some implementations, a UE may be configured with

$${N}_{i}^{SRS} {N}_{i}^{ap}$$

-port SRS resources in each SRS resource set through RRC signaling transmitted by the gNB (e.g., the parameter nrofSRS-Ports in SRS-Resource may support up to 8 antenna ports) where

$${\sum }_{i} {N}_{i}^{SRS}$$

is less than or equal to the maximum number of SRS resources per SRS Resource Set and

$${\sum }_{i} {N}_{i}^{SRS} \times {N}_{i}^{ap}$$

is equal to x times eight, where x and

$${N}_{i}^{SRS}$$

are natural numbers and

$${N}_{i}^{ap} ϵ \{ 1 , 2 , 4 , 8 \} . {N}_{i}^{ap}$$

denotes the number of SRS-ports for the SRS resource with index i, and

$${N}_{i}^{SRS}$$

denotes the number of SRS resources corresponding to index i. In addition, the configuration with at least one 8-port SRS resource may be applied to a UE that supports fully/partially/non-coherent codebook set, the configuration with only 1-port SRS resources may be applied to a UE that supports non-coherent codebook set; otherwise, the configuration may be applied to a UE that supports partially/non-coherent codebook set. It should be noted that the UE may refer to, but not limited to, a device with 8 antenna ports.

In some implementations, a UE may be configured with a parameter/IE via an RRC message to receive the antenna group information, including, for example, the number of antenna groups (e.g., N_{g}=1, 2, 4 or 8) indicating the number of antenna groups that is associated with an SRS resource set. It should be noted that the UE may refer to, but not limited to, a device with 8 antenna ports.

In some implementations, a UE may be configured with a parameter/IE via an RRC message to receive the antenna group information, including, for example, the index of an antenna group (e.g., antenna-groupId=0) indicating a specific antenna group that is associated with an SRS resource set. It should be noted that the UE may refer to, but not limited to, a device with 8 antenna ports.

In some implementations, when the gNB configures more than two SRS resources per SRS resource set to a UE, SRS resource ID and its associated antenna group may also be configured via an RRC signaling (e.g., SRS-Resource). It should be noted that a UE may refer to, but not limited to, a device with 8 antenna ports.

In some implementations, when the gNB configures more than two SRS resources per SRS resource set to a UE via an RRC signaling (e.g., SRS-Resource), SRS resource ID and its associated antenna group may also be configured via a MAC CE signaling. It should be noted that a UE may refer to, but not limited to, a device with 8 antenna ports.

In some implementations, when the gNB configures more than two SRS resources per SRS resource set to a UE via an RRC signaling (e.g., SRS-Resource), SRS resource ID and its associated antenna group may also be configured via a DCI signaling. It should be noted that a UE may refer to, but not limited to, a device with 8 antenna ports.

In some implementations, a UE may be configured with at least two 4-port SRS resources in each SRS resource set via an RRC signaling (e.g., SRS-Resource) transmitted by the gNB. In addition, each antenna group may be configured with (or associated with) a single SRS resource in one SRS resource set. The gNB may estimate the UL channel quality of each antenna group in the UE by measuring the corresponding SRS signals separately. Therefore, the gNB may or may not indicate the transmission from antenna group(s) with better UL channel quality by sending the SRI(s), which may be included in a DCI signaling, in a MAC CE field, or RRC signaling, to the UE. The gNB may indicate the transmission antenna group(s) (e.g., one transmission antenna group or two transmission antenna groups) via sending SRI to the UE and/or provide the precoding matrix information (e.g., one 4TX precoding matrix, two 4TX precoding matrices, or one 8TX precoding matrix) via sending TPMI(s) to the UE. The SRI and/or the TPMI may be included in DCI signaling, a MAC CE field, or RRC signaling. For example, the UE may receive the DCI signaling including the SRI from the gNB. The UE may receive the DCI signaling including the TPMI(s) from the gNB. The UE may receive the RRC signaling including the SRI from the gNB. The UE may receive the MAC CE including the SRI from the gNB. Moreover, these SRS configurations may be applied to a UE with the capability of supporting partial/non-coherent codebook set, and the UE may refer to a device with 8 antenna ports, which may belong to two antenna groups (e.g., N_{g}=2). It should be noted that a 4TX precoding matrix may be chosen from codebooks supporting 4TX UL transmission.

In some implementations, a UE may be configured with at least four 2-port SRS resources in each SRS resource set via an RRC signaling (e.g., SRS-Resource) transmitted by the gNB. For example, after the UE receives RRC signaling including the information of four 2-port SRS resources in each SRS resource set, from the gNB, the UE may configure itself with four SRS resources in each SRS resource set. In addition, each antenna group may be configured with (or associated with) a single SRS resource in one SRS resource set. The gNB may estimate the UL channel quality of each antenna group in the UE by measuring the corresponding SRS signals separately. Therefore, the gNB may or may not indicate the transmission antenna group(s) with better UL channel quality by sending the SRI(s), which may be included in a DCI signaling or RRC signaling, to the UE. The gNB may indicate the transmission antenna group(s) (e.g., one, two, three, or four) via sending SRI to the UE and/or provide the precoding matrix information (e.g., one/two/three/four 2TX precoding matrices, one/two 4TX precoding matrices, and/or one 8TX precoding matrix) via sending TPMI(s), which may be included in DCI signaling or RRC signaling. For example, the UE receives the DCI signaling including the SRI from the gNB. The UE receives the DCI signaling including the TPMI from the gNB. The UE receives the RRC signaling including the SRI from the gNB. The UE receives the MAC CE including the SRI from the gNB. For example, if one antenna group is indicated to the UE by sending SRI(s) from the gNB, the UE may receive information about one 2TX precoding matrix or one 8TX precoding matrix from the gNB. For example, if two antenna groups are indicated to the UE by sending SRI(s) from the gNB, the UE may receive information about two 2TX precoding matrices, one 4TX precoding matrix, or one 8TX precoding matrix from the gNB. For example, if three antenna groups are indicated to the UE by sending SRI(s) from the gNB, the UE may receive the information about three 2TX precoding matrices. For example, if four antenna groups are indicated to the UE by sending SRI(s) from the gNB, the UE may receive information about four 2TX precoding matrices, two 2TX precoding matrices and one 4TX precoding matrix, two 4TX precoding matrices, or one 8TX precoding matrix from the gNB. Moreover, these SRS configurations may be applied to a UE that supports partial/non-coherent codebook set, and the UE may refer to a device with 8 antenna ports, which may belong to four antenna groups (e.g., N_{g}=4). It should be noted that a 2TX precoding matrix may be chosen from codebooks supporting 2TX UL transmission and an 8TX precoding matrix may be chosen from codebooks supporting 8 TX UL transmission.

In some implementations, one or more SRS resource(s) configured in an SRS resource set may be associated with one antenna group, or one SRS resource set may be associated with one antenna group. After a UE receives one or more SRI value(s) indicated in the one or more DCI field(s) (e.g., SRI field(s)) included in a DCI format, such as UL DCI, DL DCI, DCI format 0_0, DCI format 0_1, or DCI format 0_2), the UE may be implicitly indicated which antenna group(s) can be applied for the UL transmission. If the UE is indicated an SRI value corresponding to one antenna group, the UE may expect that the DCI format may include one DCI field (e.g., TPMI field) indicating a TPMI value corresponding to a 2TX precoding matrix or a 4TX precoding matrix. If the UE is indicated one or more SRI value(s) corresponding to two antenna groups, the UE may expect that the DCI format may include one or more DCI field(s) (e.g., TPMI field(s)) indicating a TPMI value corresponding to a 4TX precoding matrix or an 8TX precoding matrix, or indicating one or more TPMI value(s) corresponding to two 2 TX precoding matrices. If the UE is indicated one or more SRI value(s) corresponding to three antenna groups, the UE may expect that the DCI format may include one or more DCI field(s) (e.g., TPMI field(s)) indicating a TPMI value corresponding to an 8TX precoding matrix, or indicating one or more TPMI value(s) corresponding to three 2 TX precoding matrices or one 2TX and one 4TX precoding matrices. If the UE is indicated one or more SRI value(s) corresponding to four antenna groups, the UE may expect that the DCI format may include one or more DCI field(s) (e.g., TPMI field(s)) indicating a TPMI value corresponding to an 8TX precoding matrix, or indicating one or more TPMI value(s) corresponding to four 2TX precoding matrices, two 2TX and one 4TX precoding matrices, or two 4TX precoding matrices.

In some implementations, when the gNB needs to indicate multiple precoding matrices to the UE, the gNB may inform multiple TPMIs to the UE by sending an RRC signaling or a DCI signaling. Each index in the legacy table indicating the corresponding TPMI may be combined into an index, and this index may be carried in a DCI field or an RRC parameter. For example, the index carried in the DCI field or the RRC parameter may correspond to multiple sub-indices. Each sub-index may correspond to a precoding matrix used in the legacy table, such as a 2TX precoding matrix or a 4TX precoding matrix. The UE may obtain an 8TX precoding matrix used for eight antenna ports according to the corresponding multiple 2TX precoding matrices or multiple 4TX precoding matrices indicated by the multiple sub-indices. Furthermore, the codebook subsets for each antenna group may be interdependent or independent. The UE may receive a DCI signaling or an RRC signaling and then decode the corresponding field or parameter to determine TPMIs. It should be noted that the UE may refer to, but not limited to, a device with 8 antenna ports.

In some implementations, when the gNB needs to indicate multiple precoding matrices to the UE, the gNB may inform multiple TPMIs to the UE by sending an RRC signaling or a DCI signaling. Each index in the legacy table indicating the corresponding TPMI may be included in multiple DCI fields or multiple RRC parameters. Furthermore, the codebook subsets for each antenna group may be interdependent or independent. The UE may receive a DCI signaling or an RRC signaling and then decode the corresponding fields or parameters to determine TPMIs. It should be noted that the UE may refer to, but not limited to, a device with 8 antenna ports.

In some implementations, a UE may be configured with eight 1-port SRS resources in each SRS resource set through RRC signaling transmitted by the gNB (e.g., SRS-Resource). For example, after the UE receives RRC signaling including the information of eight SRS resources in each SRS resource set, from the gNB, the UE may configure itself with eight 1-port SRS resources in each SRS resource set. In addition, each antenna group may be configured with a single SRS resource in one SRS resource set. Moreover, these SRS configurations may be applied to the UE that supports (only) non-coherent codebook set, and the UE may refer to a device with 8 antenna ports that belong to eight antenna groups (e.g., N_{g}=8).

In some implementations, a UE may be configured with more than one SRS resources in more than one SRS resource sets through RRC signaling transmitted by the gNB, and the number of SRS resources for each SRS resource set may be the same or different. For example, a first SRS resource set may be associated with two SRS resources, and a second SRS resource set may be associated with four SRS resources.

In some implementations, a UE may be configured with an indication to receive an antenna group to associate SRS resource with an antenna group. For example, more than one SRS resources may be associated with an antenna group. For example, one SRS resource may be associated with an antenna group.

In some implementations, a UE may be configured with an indication to receive an antenna group to associate SRS resource set with an antenna group. For example, more than one SRS resource sets may be associated with an antenna group. For example, one SRS resource set may be associated with an antenna group.

In some implementations, a UE may be configured with an indication to receive an antenna group to associate Transmission Precoder Matrix with an antenna group. For example, more than one Transmission Precoder Matrices may be associated with an antenna group. For example, one Transmission Precoder Matrix may be associated with an antenna group.

Generally, a UE in the present disclosure may be, but not limited to, a device with 8 antenna ports in a single antenna group (e.g., N_{g}=1), a device with 8 antenna ports in two antenna groups (e.g., N_{g}=2), a device with 8 antenna ports in four antenna groups (e.g., N_{g}=4), or a device with 8 antenna ports in eight antenna groups (e.g., N_{g}=8).

### PUSCH Configuration

The gNB may configure PUSCH Configuration (e.g., pusch-Config) to the UE via RRC signaling based on the UE capability reported by the UE, as discussed previously. In response to the reception of RRC signaling including PUSCH Configuration from the gNB, the UE may configure itself PUSCH Configuration for UL transmission. The gNB may configure SRS Configuration, as discussed previously, to the UE via RRC signaling based on the UE capability reported by a UE. In response to the reception of RRC signaling including SRS Configuration from the gNB, the UE may configure itself SRS Configuration for SRS transmission. When the UE receives RRC signaling including PUSCH Configuration with the parameter txConfig set to ‘codebook’, the UE may configure itself to the CB transmission mode.

In some implementations, when the gNB receives UE capability report including the maximum number of supporting layers from the UE, the gNB may configure the maximum transmission rank to the UE by sending RRC signal (e.g., pusch-Config) where the maximum transmission rank may be less than or equal to the maximum number of supporting layers. The maximum transmission rank may be one, two, four or eight. In response to the reception of RRC signaling including the maximum transmission rank, the UE may configure itself the maximum transmission rank for PUSCH transmission. In addition, the number of the transmission rank of the UE, determined by the DCI format(s) or high-layer parameter(s) from the gNB, may be less than or equal to the configured maximum transmission rank where the transmission rank is the number of supporting layers in PUSCH transmission. Moreover, the number of the transmission rank may depend on the measurement of the SRS signal from the UE at the gNB. It should be noted that the UE may refer to, but not limited to, a device with 8 antenna ports.

In some implementations, a UE may be configured with a parameter/IE via an RRC message to receive the antenna group information, including, for example, the number of antenna groups (e.g., N_{g}=1, 2, 4 or 8) indicating the number of antenna groups that is associated with a PUSCH transmission.

In some implementations, a UE may be configured with a parameter/IE via an RRC message received from the gNB to receive the antenna group information, including, for example, the index of an antenna group (e.g., antenna-groupId=0) indicating a specific antenna group that is associated with a PUSCH transmission.

In some implementations, a UE may be configured via MAC CE received from the gNB to receive the antenna group information, including, for example, the index of an antenna group indicating a specific antenna group that is associated with a PUSCH transmission.

In some implementations, a UE may be configured via DCI signaling received from the gNB to receive the antenna group information, including, for example, the index of antenna group indicating a specific antenna group that is associated with a PUSCH transmission.

In some implementations, a UE may report its capabilities, including the coherence information between its antenna ports, to the gNB via RRC signaling. The coherence information may be set to a certain type for indicating a coherence status (e.g., nonCoherent, partialCoherent/partialNg_2Coherent/partialNg_4Coherent, or fullCoherent/fullNg_2Coherent/fullNg_4Coherent), where the coherence information may be associated with the RRC parameter pusch-TransCoherence. It should be noted that these parameter names may be substituted with other names, for example, as specified in the 3GPP TS. For example, when the RRC parameter pusch-TransCoherence is set to “fullCoherent/fullNg_2Coherent/fullNg_4Coherent”, the UE may be capable of supporting full-coherent codebook subsets, partial-coherent codebook subsets, and noncoherent codebook subsets. For example, when the RRC parameter pusch-TransCoherence is set to “partialCoherent/partialNg_2Coherent/partiaNg_4Coheret”, the UE may be capable of supporting partial-coherent codebook subsets and noncoherent codebook subsets. For example, when the RRC parameter pusch-TransCoherence is set to “nonCoherent”, the UE may only be capable of supporting noncoherent codebook subsets.

The gNB may configure the maximum coherence capability in the RRC parameter codebookSubset or the RRC parameter codebookSubsetDCI-0-2 to the UE where the maximum coherence capability may be limited by the coherence information. The parameter codebookSubset/codebookSubsetDCI-0-2 may be set to fullyAndPartialAndNonCoherent, partialAndNonCoherent, or nonCoherent. For example, when the configured parameter codebookSubset/codebookSubsetDCI-0-2 to the UE is set to fullyAndPartialAndNonCoherent, the UE may support codebook subsets including full-coherent codebook subsets, partial-coherent codebook subsets, and noncoherent codebook subsets. For example, when the configured parameter codebookSubset/codebookSubsetDCI-0-2 to the UE is set to partialAndNonCoherent, the UE may support codebook subsets including partial-coherent codebook subsets and noncoherent codebook subsets. For example, when the configured parameter codebookSubset/codebookSubsetDCI-0-2 to UE is set to nonCoherent, the UE may support codebook subsets including only noncoherent codebook subsets. In response to the reception of RRC signaling including the maximum coherence capability, the UE may configure itself the maximum coherence capability. The parameter names may be replaced by other names. The UE may refer to, but not limited to, a device with eight antenna ports.

In some implementations, a codebook subset may be associated with an antenna group. For example, a first codebook associated with a first antenna group may correspond to fully coherent, and a second codebook associated with a second antenna group may correspond to partially coherent. For example, an antenna group index may correspond to a specific codebook type, and DCI may or may not further indicate the antenna group index for indicating the applied codebook type to a PUSCH transmission.

In some implementations, a UE may report its capabilities, including the coherence information between its antenna ports, to the gNB via RRC signaling. The coherence information may be set to nonCoherent, partialCoherent/partialNg_2Coherent/partiaNg_4Coherent, or fullCoherent/fullNg_2Coherent/fullNg_4Coherent, where the coherence information may be associated with the RRC parameter pusch-TransCoherence. For example, when the RRC parameter pusch-TransCoherence is set to “fullCoherent/fullNg_2Coherent/fullNg_4Coherent”, the UE may be capable of supporting full-coherent codebook subsets, partial-coherent codebook subsets, and noncoherent codebook subsets. For example, when the RRC parameter pusch-TransCoherence is set to “partialCoherent/partialNg_2Coherent/partialNg_4Coherent”, the UE may be capable of supporting partial-coherent codebook subsets and noncoherent codebook subsets. For example, when the RRC parameter pusch-TransCoherence is set to “nonCoherent”, the UE may only be capable of supporting noncoherent codebook subsets.

The gNB may configure the maximum coherence capability in the RRC parameter codebookSubset or the RRC parameter codebookSubsetDCI-0-2 to the UE where the maximum coherence capability may be limited by the coherence information. The parameter codebookSubset/codebookSubsetDCI-0-2 may be set to fullyAndPartialNg_2AndNonCoherent/fullyAndPartialNg_4AndNonCoherent, partialNg_2AndNonCoherent/partialNg_4AndNonCoherent, or nonCoherent. For example, when the configured parameter codebookSubset/codebookSubsetDCI-0-2 to the UE is set to fullyAndPartialNg_2AndNonCoherent/fullyAndPartialNg_4AndNonCoherent, the UE may support codebook subsets including full-coherent codebook subsets, partial-coherent codebook subsets, and noncoherent codebook subsets. For example, when the configured parameter codebookSubset/codebookSubsetDCI-0-2 to the UE is set to partialNg_2AndNonCoherent/partialNg_4AndNonCoherent, the UE may support codebook subsets including partial-coherent codebook subsets and noncoherent codebook subsets. For example, when the configured parameter codebookSubset/codebookSubsetDCI-0-2 to UE is set to nonCoherent, the UE may support codebook subsets including only noncoherent codebook subsets. Moreover, fullyAndPartialNg_2AndNonCoherent/fullyAndPartialNg_4AndNonCoherent means that codebook subsets with two/four antenna groups supporting fully coherent, partial-coherent for two/four antenna groups, and non-coherent cases are enabled, partialNg_2AndNonCoherent/partialNg_4AndNonCoherent means that codebook subsets with two/four antenna groups supporting partial-coherent for two/four antenna groups and non-coherent cases are enabled, and nonCoherent means that codebook subsets supporting non-coherent cases are enabled. In response to the reception of RRC signaling including the maximum coherence capability, the UE may configure itself the maximum coherence capability. The parameter names may be replaced by other names, and the UE may refer to, but not limited to, a device with eight antenna ports.

In some implementations, the full power modes may be designed based on the antenna port architecture, codebook design, and/or SRS configuration. The gNB may configure one mode to the UE via sending RRC signaling including the parameter ul-FullPowerTransmission. In response to the reception of received RRC signaling, the UE may configure itself the full power mode for PUSCH transmission, where the parameter ul-FullPowerTransmission may be in a field in pusch-Config.

The uplink full power transmission may support several modes designed based on the antenna port architecture and codebook design, and the gNB may configure one mode to the UE depending on the UE capability (e.g., support codebook subset in the UE capability), where the supporting full power mode may be configured in a field in pusch-Config (e.g., ul-FullPowerTransmission). The parameter ul-FullPowerTransmission may be set to one mode among full power modes. For example, the full power modes may be related to the parameter ul-FullPowerTransmission and the parameter ul-FullPowerTransmission may be, but not limited to, set to ‘fullpower’, ‘fullpowerMode1’ or ‘fullpowerMode2’. The UE may refer to, but not limited to, a device with eight antenna ports.

In some implementations, the feasibility of transform precoding may or may not be supported depending on the UE capability (e.g., support codebook subset in the UE capability). The gNB may configure the UE with a higher layer parameter included in the RRC signaling to determine whether to “enable” or “disable” transform precoding. In response to the reception of RRC signaling including the information of supporting transform precoding, the UE may configure whether the transform precoding is “enabled” or “disabled” for itself. For example, when the UE is configured with the higher layer parameter msg3-transformPrecoder, the UE may determine that the transform precoding is either ‘enabled’ or ‘disabled’ where the PUSCH is scheduled by RAR UL grant, fallbackRAR UL grant, or DCI format 0_0 with CRC scrambled by TC-RNTI. For example, when the UE is configured with the higher layer parameter msgA-TransformPrecoder, the UE may determine that the transform precoding is either ‘enabled’ or ‘disabled’ for the MsgA PUSCH. For example, when the UE is configured with the higher layer parameter msg3-transformPrecoder, UE may determine that the transform precoding is either ‘enabled’ or ‘disabled’ where the PUSCH is scheduled by PDCCH with CRC scrambled by CS-RNTI with NDI=1, C-RNTI, MCS-C-RNTI, or SP-CSI-RNTI. For example, when the UE is configured with the higher layer parameter transformPrecoder in pusch-Config, the UE may determine that the transform precoding is either ‘enabled’ or ‘disabled’ where the PUSCH is scheduled by PDCCH with CRC scrambled by CS-RNTI with NDI=1, C-RNTI, MCS-C-RNTI, or SP-CSI-RNTI. For example, when the UE is configured with the higher layer parameter transformPrecoder in configuredGrantConfig, the UE may determine that the transform precoding is either ‘enabled’ or ‘disabled’ for PUSCH transmission with a configured grant. For example, when the UE is configured with the higher layer parameter msg3-transformPrecoder, the UE may determine that the transform precoding is either ‘enabled’ or ‘disabled’ for PUSCH transmission with a configured grant. When transform precoding is set to ‘enabled’, the gNB may indicate to the UE one or more precoders from the codebook subsets supporting transform precoding. The UE may refer to, but not limited, a device with eight antenna ports. In one example, the transform precoder(s) may be enabled or disabled per antenna group. For example, the transform precoder(s) may be enabled or disabled in all antenna groups simultaneously. Moreover, the codebook subsets supporting transform precoding may support up to 8TX scenarios.

In some implementations, the 3GPP TS may define one or more tables of precoding matrices. Each table may give a one-to-one mapping between TPMI indices and precoding matrices, where the precoding matrices may be used for single-layer, two-layer, three-layer, four-layer, five-layer, six-layer, seven-layer, or eight-layer (PUSCH) transmission using one, two, four, eight antenna ports with transform precoding disabled or may be used for single-layer (PUSCH) transmission using one, two, four, or eight antenna ports with transform precoding enabled.

In some implementations, a UE may receive precoding information, layer information, and/or antenna information through a dedicated table that defines the number of layers, TPMI value, antenna group value, and/or codebook subset for 8TX PUSCH transmission. In some implementations, the dedicated table may include information only specific to 8TX scenarios only.

In some implementations, a UE may receive precoding information, and/or layer information through a dedicated table that defines the number of layers, TPMI value, and/or codebook subset for 8TX PUSCH transmission. In some implementations, the dedicated table may include information only specific to 8TX scenarios only.

In some implementations, a UE may receive precoding information, layer information, and/or antenna information through a table with extended entries that defines the number of layers, TPMI value, antenna group value, and/or codebook subset for 8TX PUSCH transmission. In some implementations, the table may include entries specific to providing information for 8TX PUSCH transmission.

In some implementations, a UE may receive precoding information, layer information, and/or antenna information through a table with extended entries that defines the number of layers, TPMI value, antenna group value, and/or codebook subset for 8TX PUSCH transmission. In some implementations, the table may include entries specific to providing information for 8TX PUSCH transmission.

It should be noted that the UE may determine the precoder(s) via searching the table, where the table may include, but not limited to, two columns. The first column may be associated with “bit field mapped to index”, and the second column may be associated with the number of layers and its TPMI. Moreover, the codebook subset associated with the second column may be determined by PUSCH Configuration. The index in the first column may correspond to one number of transmission layers with one TPMI value in the second column. The number of rows in the table may be determined by the number of antenna ports and the parameters including a transform precoding configuration (e.g., transformPrecoder), a maximum transmission rank (e.g., maxRank), codebookSubset, a full power mode configuration (ul-FullPowerTransmission), where the parameters may be configured in the PUSCH configuration (e.g., pusch-Config). The gNB may configure/schedule the UE with the index or indices via sending RRC signaling/DCI signaling. In response to the reception of RRC signaling/DCI signaling including the index or indices, the UE may determine the precoders by searching the corresponding table based on the received index or indices. The UE may refer to, but not limited to, a device with eight antenna ports.

### Precoder(s) Selection

For CB transmission, the gNB may instruct the UE to determine precoder(s) based on PUSCH configuration via sending DCI signaling/RRC signaling. Moreover, the UE may determine its PUSCH transmission precoder(s) based on SRI(s), TPMI(s) and the transmission rank. The SRI(s), TPMI(s) and the transmission rank (number of layers) may be given by DCI fields of one or two SRS resource indicators and one or two Precoding information and number of layers field(s). The DCI field may be included in a DCI format such as DCI format 0_1, DCI format 0_2, or other DCI formats for scheduling an UL transmission. Moreover, the SRI(s), TPMI(s) and the transmission rank (layers) may be given by the higher layer parameters (e.g., RRC signaling) srs-ResourceIndicator and precodingAndNumberOfLayers or srs-ResourceIndicator, srs-ResourceIndicator2, precodingAndNumberOfLayers, precodingAndNumberOfLayers2 to the UE from the gNB via an RRC message. After receiving the information of the SRI(s), TPMI(s) and the transmission rank (layers), the UE may determine the transmission precoder(s) via searching the codebookSubset table based on the parameters including a transform precoding configuration (e.g., transformPrecoder), a maximum transmission rank (e.g., maxRank), codebookSubset, a full power mode configuration (ul-FullPowerTransmission). In addition, the UE may determine the transmission antenna group(s) based on the received SRI(s). For example, when the UE configures each antenna group with a single SRS resource by receiving SRS Configuration from the gNB, the gNB may receive SRS signals from different antenna groups sequentially. Thus, the gNB may send the SRI(s) to the UE via RRC signaling/DCI signaling. In response to the RRC signaling/DCI signaling including the SRI(s), the UE may determine the transmission antenna group(s) based on the indicated SRS resource(s). It should be noted that the UE may refer to, but not limited to, a device with eight antenna ports.

In some implementations, the gNB may inform the UE of the SRI to indicate one SRS resource among received SRS resources from the UE. Moreover, the UE may get the index from the received SRI, and then search the SRI table determined by ul-FullPowerTransmission and N_{SRS} to determine the corresponding SRS resource, where N_{SRS} is the number of configured SRS resources in the SRS resource set configured by higher layer parameter srs-ResourceSetToAddModList and associated with the higher layer parameter usage of value ‘codebook’. In addition, the SRI table may contain two columns, the first column may be associated with “bit field mapped to index”, and the second column may be associated with the SRS tags. The number of rows of the SRI table may be determined by N_{SRS}. After identifying the corresponding SRS resource indicated by the SRI, the UE may determine which antenna group(s) may be used to transmit data based on the SRS configuration. It should be noted that the UE may refer to, but not limited to, a device with eight antenna ports.

In some implementations, the gNB may inform the UE of the SRI to indicate the number of SRS resources from one to N_{SRS} among the received SRS resources included in a configured SRS resource set. Moreover, the UE may get the index from the received SRI, and then the UE may search the SRI table determined by the parameter ul-FullPowerTransmission and N_{SRS} to determine the corresponding SRS resource, where N_{SRS} may be determined by the number of SRS resources combination. In addition, the SRI table may contain two columns. The first column may be associated with “bit field mapped to index”, and the second column may be associated with the combination tags. The number of rows of the SRI table may be determined by the number of SRS resources combination. After identifying the corresponding SRS resources indicated by the SRI, the UE may determine which antenna(s) may be used to transmit data based on the SRS configuration. The UE may refer to, but not limited to, a device with eight antenna ports.

In some implementations, the transmission rank (layers) in each indicated antenna group may or may not be equal. For example, the gNB may indicate different transmission ranks to each UE via sending multiple transmission ranks and its TPMI in a field in DCI signaling or a higher layer parameter in RRC signaling. In response to the reception of DCI signaling or RRC signaling, the UE may determine the transmission rank of each antenna group. The UE may refer to, but not limited to, a device with eight antenna ports in the present disclosure.

In some implementations, the gNB may inform the UE of the TPMI and the transmission rank (layers) to indicate the precoder. Moreover, the UE may get the index from the received DCI signaling or the received RRC signaling, and then search the precoding information and number of layers table determined by the number of antenna ports and the parameters including at least transformPrecoder, maxRank, codebookSubset, ul-FullPowerTransmission. In some implementations, if the UE is configured/indicated to use eight antenna ports for the (PUSCH) transmission(s) scheduled by the DCI signaling or configured by the RRC signaling, the UE may determine that the precoding information and number of layers table is a table of precoding matrix W for N-layer transmission using eight antenna ports, where N may be one (single), two, three, four, five, six, seven or eight. In addition, the precoding information and number of layers table may contain two columns. The first column may be associated with “bit field mapped to index”, and the second column may be associated with the number of layers (e.g., the transmission rank) and its TPMI. The number of rows in the precoding information and number of layers table may be determined by the number of antenna ports and the parameters including at least transformPrecoder, maxRank, codebookSubset, ul-FullPowerTransmission, where the parameters may be configured in pusch-Config fields. After decoding the precoding information and number of layers indicated by the received DCI signaling or the received RRC signaling, the UE may determine which precoder may be used to transmit data. The dimension of the indicated precoder (precoding matrix) may be the number of antenna ports×the transmission rank.

In some implementations, the received SRI field may indicate only one SRS resource to the UE and the indicated SRS resource may correspond to a single antenna group of the UE. The gNB may inform the UE of the TPMI and the transmission rank (layers) to indicate the precoder. The UE may obtain the index from the received signaling, and then search the precoding information and number of layers table determined by the number of antenna ports and the parameters including at least transformPrecoder, maxRank, codebookSubset, ul-FullPowerTransmission, where the tables supporting 2TX or 4TX may be reused for the precoding information and the number layers table. Thus, the UE may determine the indicated precoder where the dimension of the indicated precoder (precoding matrix) is the number of antenna ports of the indicated antenna group×the transmission rank. Based on the indicated precoder, the UE may determine the transmission precoding matrix by combining the indicated precoder and zero entries into one matrix where the size of the transmission precoding matrix is the number of antenna ports×the transmission rank and the indicated precoder is placed at the position corresponding to the indicated antenna group. For example, the indicated matrix may be represented as A and then the transmission precoding matrix W may be represented as

$$[ \begin{matrix}A \\ 0\end{matrix} ] or [ \begin{matrix}0 \\ A\end{matrix} ]$$

based on the indicated antenna group where 0 represents a zero matrix. Moreover, the dimension of the zero matrix is (the number of antenna ports−the number of antenna ports of the indicated antenna group)×the transmission rank. Although the UE may have multiple indicated precoding matrices, a single transmission precoding matrix may be used in PUSCH transmission by the UE.

In some implementations, the received SRI field may indicate multiple SRS resources to the UE and the indicated SRS resources may correspond to multiple antenna group of the UE. On the other hand, the gNB may inform the UE of the TPMIs and the transmission ranks (layers) to indicate the precoders. When the TPMIs and the transmission ranks is included in the field(s) of DCI signaling, the number of fields may be in one or two of DCI signaling. The UE may get the index(s) from the received signaling, and then search the precoding information and number of layers table determined by the number of antenna ports and the parameters including at least transformPrecoder, maxRank, codebookSubset, ul-FullPowerTransmission, where the tables supporting 2TX or 4TX may be reused. Thus, the UE may determine the indicated precoders where the dimension of each indicated precoder (precoding matrix) is the number of antenna ports of the indicated antenna group×the transmission rank of each indicated antenna group. Moreover, the index obtained from the gNB for the UE may be generated by combining the indexes from the legacy tables supporting 2TX or 4TX. For example, an index with four bits may include the first two bits and the last two bits, where the first two bits correspond to a first index (which may also be referred to as a first sub-index) in one of the legacy tables corresponding to a first precoder applicable to 4TX, and the last two bits correspond to a second index (which may also be referred to as a second sub-index) in one of the legacy tables corresponding to a second precoder applicable to 4TX. It should be noted that the method of combining indexes from the legacy tables is not limited to the above-mentioned method where bits are arranged sequentially. Other methods of combination indexes may also be applicable in some implementations. Based on the indicated precoders, the UE may determine the transmission precoding matrix by combining the indicated precoders and zero entries into one matrix where the size of the transmission precoding matrix is the number of antenna ports×the transmission rank and each indicated precoder is placed at the position corresponding to each indicated antenna group. For example, the indicated precoding matrices may be represented as A₁ and A₂. Therefore, the transmission precoding matrix W may be represented as

$$[ \begin{matrix}{A}_{1} & 0 \\ 0 & {A}_{2}\end{matrix} ] or [ \begin{matrix}{A}_{2} & 0 \\ 0 & {A}_{1}\end{matrix} ]$$

based on the indicated antenna group where 0 represents a zero matrix. Moreover, the dimension of each zero matrix may be (the number of antenna ports−the number of antenna ports of the indicated antenna group)×the transmission rank of the indicated antenna group. Although the UE may have multiple indicated precoding matrices, a single transmission precoding matrix may be used in PUSCH transmission by the UE.

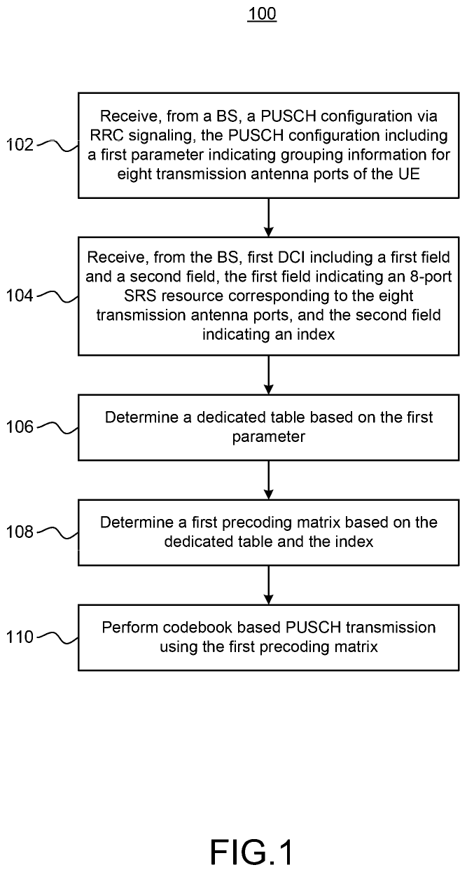

FIG. 1 is a flowchart 100 illustrating a method/process for codebook based PUSCH transmission performed by a UE, according to an example implementation of the present disclosure. In action 102, the UE may receive, from a BS, a PUSCH configuration (e.g., pusch-Config) via RRC signaling. The PUSCH configuration may include a first parameter indicating grouping information for eight transmission antenna ports of the UE. For example, the grouping information may include the number of antenna groups (e.g., N_{g}) and/or how the eight transmission antenna ports of the UE are distributed in each antenna group.

In some implementations, the first parameter may indicatee the number of antenna groups, which may be one, two, four, or eight. Transmission antenna ports that belong to the same antenna group are regarded as coherent.

In action 104, the UE may receive, from the BS, first DCI including a first field and a second field. The first field may indicate an 8-port SRS resource corresponding to the eight transmission antenna ports, and the second field may indicate an index. In some implementations, the first field may correspond to an SRI. In some implementations, the second field may correspond to precoding information and number of layers.

In some implementations, the first DCI may schedule an UL transmission, such as a codebook based PUSCH transmission. In some implementations, the first DCI may be a DCI format 0_1 or DCI format 0_2.

In action 106, the UE may determine a dedicated table based on the first parameter. Therefore, the dedicated table may be determined based on grouping information for the eight transmission antenna ports of the UE. The dedicated table may include one or more precoding matrices used for precoding.

In some implementations, the PUSCH configuration further includes a maximum transmission rank, a transform precoding configuration, and a full power mode configuration. The UE may determine the dedicated table further based on the maximum transmission rank, the transform precoding configuration, and the full power mode configuration. In some implementations, a maximum value of the maximum transmission rank may be eight.

In some implementations, the dedicated table has two columns for each value of the maximum transmission rank. For example, the maximum transmission rank may be ranged from one to eight, and there may be one table for each value of the maximum transmission rank. The first column of the dedicated table may corresponds to the index, as indicated in the second field of the first DCI. The second column of the dedicated table may correspond to a combination of the number of transmission layers and a TPMI.

In action 108, the UE may determine a first precoding matrix based on the dedicated table and the index. For example, the first precoding matrix may be obtained from the second column of the dedicated table by looking up the index in the first column of the dedicated table.

In some implementations, the index may correspond to multiple sub-indices. The first precoding matrix may be obtained according to multiple second precoding matrices, where the second precoding matrices correspond to sub-indices, and each of the second precoding matrices may be used for four transmission antenna ports or two transmission antenna ports. For example, the first precoding matrix used for eight transmission antenna ports may be obtained by combining two second precoding matrices used for four transmission antenna ports, and the index may correspond to two sub-indices used in the associated two second precoding matrices. For example, the first precoding matrix may be obtained by combining four second precoding matrices used for two transmission antenna ports, and the index may correspond to four sub-indices used in the associated four second precoding matrices.

In action 110, the UE may perform codebook based PUSCH transmission using the first precoding matrix.

The technical problem addressed by the method illustrated in FIG. 1 is codebook based PUSCH transmission in a wireless communication system, particularly for a UE with eight transmission antenna ports. The grouping information for the eight transmission antenna ports is provided in the PUSCH configuration via RRC signaling and the precoding matrix is determined based on the grouping information. The advantageous technical effect achieved by the method is the optimization of PUSCH transmission through a codebook-based approach. The grouping information for the transmission antenna ports may take the coherence characteristic of the transmission antenna ports into consideration. Therefore, the use of a dedicated table based on received parameters, such as the grouping information for the transmission antenna ports, and the subsequent determination of the precoding matrix contribute to reduction of signaling overhead and efficient utilization of resources during PUSCH transmission, leading to enhanced overall system performance.

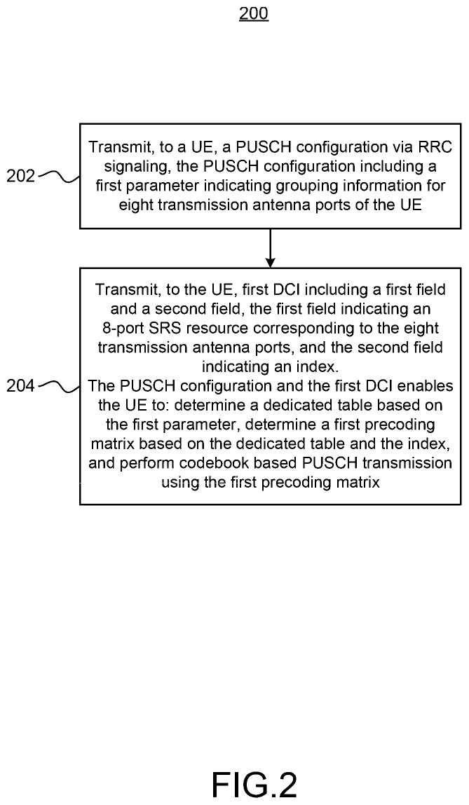

FIG. 2 is a flowchart 200 illustrating a method/process for configuring codebook based PUSCH transmission performed by a BS, according to an example implementation of the present disclosure. In action 202, the BS may transmit, to a UE, a PUSCH configuration via RRC signaling, the PUSCH configuration including a first parameter indicating grouping information for eight transmission antenna ports of the UE. In action 204, the BS may transmit, to the UE, first DCI including a first field and a second field, the first field indicating an 8-port SRS resource corresponding to the eight transmission antenna ports, and the second field indicating an index. The PUSCH configuration and the first DCI enables the UE to: determine a dedicated table based on the first parameter, determine a first precoding matrix based on the dedicated table and the index, and perform codebook based PUSCH transmission using the first precoding matrix. The method illustrated in FIG. 2 is similar to that in FIG. 1 except that it is described from the perspective of the BS.

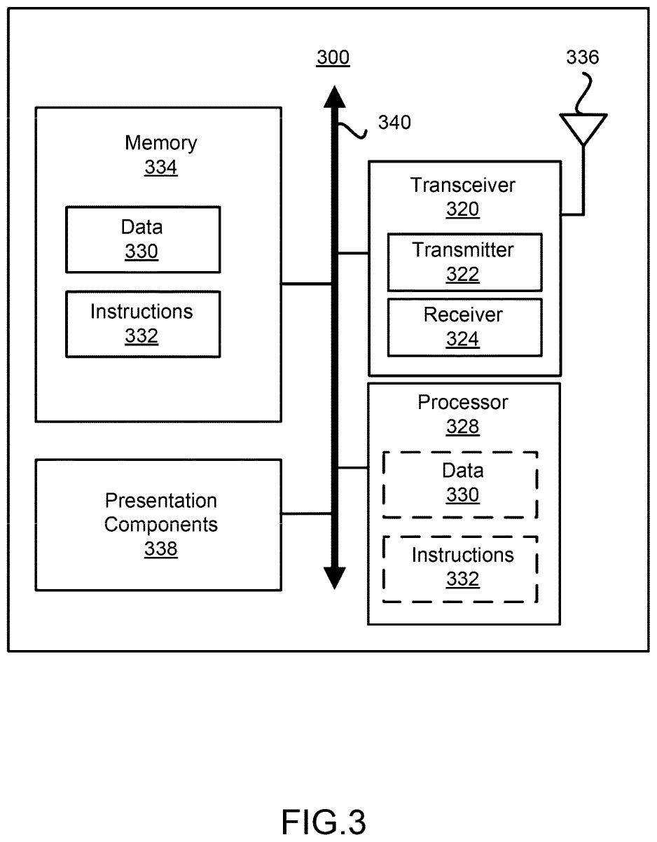

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIGS. 1 through 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 through 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for codebook based Physical Uplink Shared Channel (PUSCH) transmission, the method comprising:
receiving, from a base station (BS), a PUSCH configuration via Radio Resource Control (RRC) signaling, the PUSCH configuration including a first parameter indicating grouping information for eight transmission antenna ports of the UE;
receiving, from the BS, first Downlink Control Information (DCI) including a first field and a second field, the first field indicating an 8-port Sounding Reference Signal (SRS) resource corresponding to the eight transmission antenna ports, and the second field indicating an index;
determining a dedicated table based on the first parameter;
determining a first precoding matrix based on the dedicated table and the index; and
performing codebook based PUSCH transmission using the first precoding matrix.

2-7. (canceled)

8. A user equipment (UE) for codebook based Physical Uplink Shared Channel (PUSCH) transmission, the UE comprising:
at least one processor; and
at least one non-transitory computer-readable medium coupled to the at least one processor and storing one or more computer-executable instructions that, when executed by the at least one processor, cause the UE to;
receive, from a base station (BS), a PUSCH configuration via Radio Resource Control (RRC) signaling, the PUSCH configuration including a first parameter indicating grouping information for eight transmission antenna ports of the UE;
receive, from the BS, first Downlink Control Information (DCI) including a first field and a second field, the first field indicating an 8-port Sounding Reference Signal (SRS) resource corresponding to the eight transmission antenna ports, and the second field indicating an index;
determine a dedicated table based on the first parameter;
determine a first precoding matrix based on the dedicated table and the index; and
perform codebook based PUSCH transmission using the first precoding matrix.

9. A base station (BS) for configuring codebook based Physical Uplink Shared Channel (PUSCH) transmission, the BS comprising:
at least one processor; and
at least one non-transitory computer-readable medium coupled to the at least one processor and storing one or more computer-executable instructions that, when executed by the at least one processor, cause the BS to:
transmit, to a user equipment (UE), a PUSCH configuration via Radio Resource Control (RRC) signaling, the PUSCH configuration including a first parameter indicating grouping information for eight transmission antenna ports of the UE; and
transmit, to the UE, first Downlink Control Information (DCI) including a first field and a second field, the first field indicating an 8-port Sounding Reference Signal (SRS) resource corresponding to the eight transmission antenna ports, and the second field indicating an index, wherein the UE:
determines a dedicated table based on the first parameter,
determines a first precoding matrix based on the dedicated table and the index, and
performs codebook based PUSCH transmission using the first precoding matrix.

10. The BS of claim 9, wherein the first DCI comprises one of a DCI format 0_1 or a DCI format 0_2.

11. The BS of claim 9, wherein:
the first parameter indicates a number of antenna groups, and
transmission antenna ports that belong to a same antenna group are coherent.

12. The BS of claim 9, wherein:
the index corresponds to a plurality of sub-indices,
the first precoding matrix is obtained based on a plurality of precoding matrices,
the plurality of precoding matrices is associated with the plurality of sub-indices, and
each of the plurality of precoding matrices is used for four transmission antenna ports or two transmission antenna ports.

13. The BS of claim 9, wherein:
the PUSCH configuration further includes a maximum transmission rank, a transform precoding configuration, and a full power mode configuration, and
the dedicated table is determined further based on the maximum transmission rank, the transform precoding configuration, and the full power mode configuration.

14. The BS of claim 13, wherein a maximum value of the maximum transmission rank is eight.

15. The BS of claim 13, wherein:
the dedicated table has two columns for each value of the maximum transmission rank,
the first column of the dedicated table corresponds to the index, and
the second column of the dedicated table corresponds to a combination of a number of transmission layers and a Transmitted Precoding Matrix Indicator (TPMI).

16. The UE of claim 8, wherein the first DCI comprises one of a DCI format 0_1 or a DCI format 0_2.

17. The UE of claim 8, wherein:
the first parameter indicates a number of antenna groups, and
transmission antenna ports that belong to a same antenna group are coherent.

18. The UE of claim 8, wherein:
the index corresponds to a plurality of sub-indices,
the first precoding matrix is obtained based on a plurality of precoding matrices,
the plurality of precoding matrices is associated with the plurality of sub-indices, and
each of the plurality of precoding matrices is used for four transmission antenna ports or two transmission antenna ports.

19. The UE of claim 8, wherein:
the PUSCH configuration further includes a maximum transmission rank, a transform precoding configuration, and a full power mode configuration, and
the dedicated table is determined further based on the maximum transmission rank, the transform precoding configuration, and the full power mode configuration.

20. The UE of claim 19, wherein a maximum value of the maximum transmission rank is eight.

21. The UE of claim 19, wherein:
the dedicated table has two columns for each value of the maximum transmission rank,
the first column of the dedicated table corresponds to the index, and
the second column of the dedicated table corresponds to a combination of a number of transmission layers and a Transmitted Precoding Matrix Indicator (TPMI).
